(19) United States
(12) Patent Application Publication
(10) Pub. No.: US 2006/0063115 A1
(43) Pub. Date: Mar. 23, 2006

(54) System for making a photograph with a separable border portion

(75) Inventor: Carl D. Neuburger, Woodbury, MN (US)

Correspondence Address: PILLSBURY WINTHROP SHAW PITTMAN, LLP, P.O. BOX 10500, MCLEAN, VA, 22102, US

(73) Assignee: InVision Enterprises International Inc., Palatine, IL (US)

(21) Appl. No.: 11/228,246

(22) Filed: Sep. 19, 2005

Related U.S. Application Data
(60) Provisional application No. 60/610,965, filed on Sep. 20, 2004.

(51) Int. Cl. G03C 1/00

(52) U.S. Cl. 430/496

(57) ABSTRACT

A system for making a photograph comprises a photograph substrate having a photographic image printable surface. The photograph substrate has a main image receiving portion for receiving the photographic image and a relatively thin border portion releasably attached along an entire peripheral edge of the main portion. The border portion is manually separable. A method for making a photograph comprises: (a) providing a system comprising a photograph substrate having a photographic image printable surface, the photograph substrate having a main image receiving portion and a relatively thin border portion releasably attached along an entire peripheral edge of the main portion, the border portion being manually separable from the main portion; (b) printing an image on the photographic image printable surface at least on the main image receiving portion; and (c) manually separating the relatively thin border portion from the entire peripheral edge of the main image receiving portion.

The present application claims priority to U.S. Provisional Application Ser. No. 60/610,965, filed Sep. 20, 2004, the entirety of which is hereby incorporated by reference.

### FIELD OF THE INVENTION

The present invention relates to photograph substrates onto which images are printed.

### BACKGROUND OF THE INVENTION

Substrates with image receiving surfaces especially designed for having photographic images printed thereon by inkjet or other types of printers are well known.

Often, photograph substrates for receiving printed image are sold in standard sizes, such as rectangular 4 inches by 6 inches, 5 inches by 7 inches, etc. Such photograph substrates are typically fed into a printer and an image is printed directly onto the substrate, resulting in the finished end product. Such images are usually printed so as to fully cover the photograph substrate, or to provide a relatively thin unprinted border along the edge of the substrate. When the image is being printed so as to fully cover the substrate, the image may occasionally be slightly misaligned. This typically arises from misfeeding of the photograph substrate into the printer, but may also arise from a software error in instructing the printer where to print the image. Either way, the result is that a small white space or strip is typically left on one edge of the substrate, which gives the photograph an overall poor appearance.

### SUMMARY OF THE INVENTION

One aspect of the invention provides a system for making a photograph. The system comprises a photograph substrate having a photographic image printable surface onto which a printer can print a photographic image. The photograph substrate has a main image receiving portion for receiving the photographic image and a relatively thin border portion releasably attached along an entire peripheral edge of the main portion. The border portion is manually separable from the main portion.

Another aspect of the invention provides a method for making a photograph. The method comprises:

providing a system comprising a photograph substrate having a photographic image printable surface onto which a printer can print a photographic image, the photograph substrate having a main image receiving portion and a relatively thin border portion releasably attached along an entire peripheral edge of the main portion, the border portion being manually separable from the main portion;

printing an image on the photographic image printable surface at least on the main image receiving portion; and

manually separating the relatively thin border portion from the entire peripheral edge of the main image receiving portion.

Other objects, features, and advantages of the present invention will become apparent from the following detailed description, the accompanying drawings, and the appended claims.

### BRIEF DESCRIPTION OF THE DRAWINGS

FIG. 1 is a top view of a system for making a photograph constructed in accordance with an embodiment of the invention.

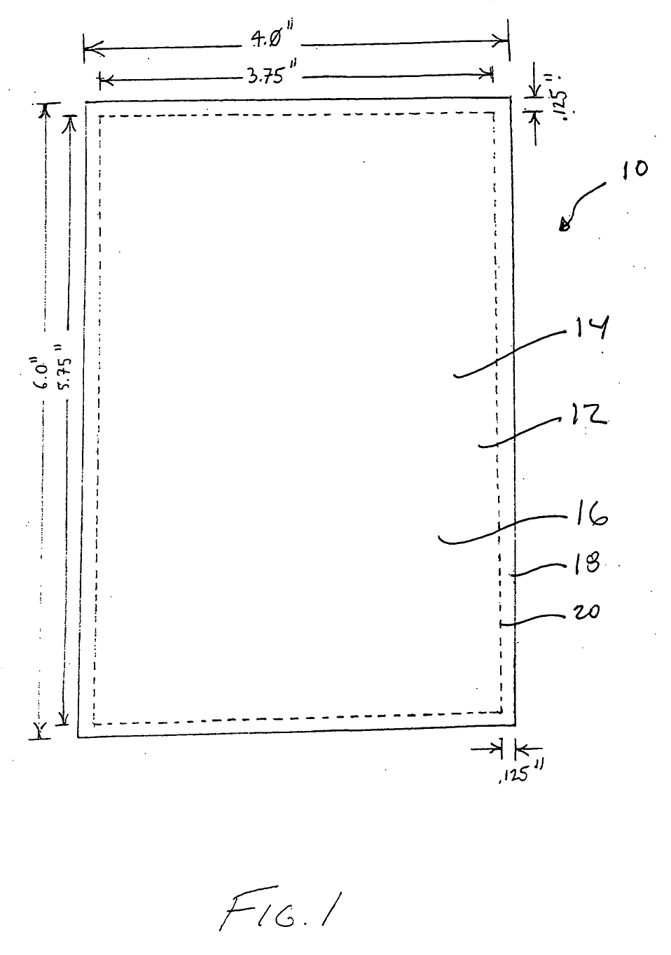

### DETAILED DESCRIPTION OF THE ILLUSTRATED EMBODIMENT

The Figures illustrate a system 10 for making a photograph. The system 10 comprises a photograph substrate 12 having a photographic image printable surface 14 onto which a printer can print a photographic image. The photograph substrate 12 has a main image receiving portion 16 for receiving the photographic image and a relatively thin border portion 18 releasably attached along an entire peripheral edge 20 of the main portion 16. The border portion 18 is manually separable from the main portion 16.

As used in this application, the term photograph substrate means a substrate with a surface (i.e., the photographic image printable surface 14) especially adapted by a treating or coating for having photographic images printed thereon. Such substrates are characterized by enabling printed photographic images to have a sharp, bright colorful images with high color intensity, and may be designed for use with ink jet printers, dye sublimation printers, or any other type of printer. For example, such substrates may include high quality micro-porous polyethylene coated paper, or a paper with some other coating that serves to enhance printer output by reducing diffusion of the dye or ink, improving hold out, reducing drying time, and/or improving scratch resistance. Other types of coatings may be used. This definition excludes normal paper or other substrates not especially adapted for having photographic images printed thereon.

To enable the border portion 18 to be manually separated from the main image receiving portion 16, the edge 20 is provided with a series of spaced apart linear perforations to structurally weaken the interface between the two portions. The portions remaining in between the perforations releasably attach the border portion 18. This facilitates the manual separation of the border portion 18 from the main portion 16, as will be discussed below. The perforations may extend through the entire thickness of the substrate 20. Alternatively, other ways of structurally weakening the substrate 12 along edge 20 may be used for facilitating manual separation of the border portion 18 from the main portion 16 (e.g., any frangible connection). For example, a continuous score line extending only partially through the thickness of the substrate 12 may be formed along the edge, instead of spaced apart perforations. Such perforations or the score line may be formed by die cutting or in any other suitable fashion.

The illustrated photograph substrate 12 is 4 inches by 6 inches overall. This is a standard photograph size. Other sizes, such as 5 inches by 7 inches, 3 inches by 5 inches, or any other size, may be used. The border portion 18 is ⅛ of an inch and extends around the entire periphery of the photograph substrate 12 (and hence along the entire edge 20 of the main portion 16). The border portion 18 may be of any size, but it is preferable that the size be thin enough so that the main portion 16 left after removing the border portion 18 is close to the original full size of the substrate 12, yet large enough so that any unprinted areas occur only on the border portion 18. Any suitable relatively thin size can serve this purpose. By relatively thin, it is meant that the border portion has a small dimension in the plane of the substrate 12 in comparison to the overall size (i.e., width and length) of the substrate 12. Other suitable dimensions may be, for example, 1/16 of an inch or 3/16 of an inch for the border portion 18. With a ⅛ inch border portion 18 on the illustrated 4 inch by 6 inch photograph substrate 12, the resulting main image receiving portion 16 will have a width of 3.75 inches and a length of 5.75 inches.

The photograph substrate 12 may also be shaped as an oval, cirlce, or in some other shape.

The system 10 with a blank photo substrate 12 can be fed individually, either manually or by a sheet feeder from a stack, into a printer (not shown) that is capable of printing photographic images received from a memory in a personal computer or other type of device. Such images are stored in digital format, and may be compressed for saving memory space in accordance with a compression algorithm. For example, the printer could receive the images directly from a digital camera coupled to the printer, or the printer may have a port for receiving a storage medium on which the images are stored and a device for reading those images from the medium. The particular way in which the printer receives the images is not of particular importance and the invention is not intended to be limited to any specific way.

The printer then prints the photographic image on the photographic image printable surface 14. This printing may occur in any suitable way, whether by ink jet printing, dye sublimation or some other suitable method. The system 10 with the substrate 12 is then discharged from the printer. During printing, the image is printed on at least the main image receiving portion 16, and usually over the entire substrate 12, including the border portion 18.

Once the substrate 12 is discharged from the printer, the user may manually separate the relatively thin border portion 18 from the entire peripheral edge 20 of the main image receiving portion 16. Specifically, because the interface between the border portion 18 and the main portion 16 is perforated or otherwise structurally weakened, the user can manually separate the border portion 18 along the interface at the peripheral edge 20. The resulting end product is a photograph in the form of the main portion 16 with a clean edge 20. If there were any slight misalignment of the printed image on the substrate 12, the unprinted area will be on the border portion 18, which has now been separated and discarded. The main image receiving portion 16 will have full coverage with no white spaces or strips along any of its edges.

As an alternative, the photograph substrate 12 may have an adhesive, such as a pressure-sensitive adhesive, coated on its backside opposite the image printable surface 14. A release liner (not shown) having the same configuration and size as the photograph substrate 12, or a slightly larger size, would cover and be adhered to the adhesive. The surface contacting the adhesive would have a release coating, such as wax, silicone, etc. Thus, when the user wants to apply the photograph substrate to a surface as a label, the user can just peel off the release liner, leaving the adhesive on the photographic substrate 12. Then, the user can separate the border portion 18 as discussed above, and adhere the backside of the main image receiving portion 16 to the surface as desired.

As an alternative to eliminate the need for the user to handle the border portion 18 with exposed adhesive, the release liner could likewise have perforations or some structurally weakened feature that is parallel and aligned with the interface between the main portion 16 and the border portion 18 at edge 20. This would allow the user to separate both the border portion 18 of the photograph substrate 12 and a border portion of the release liner at the same time prior to peeling any part of the release liner off the adhesive. During manufacturing, the perforations or weakened portions may be formed in the release liner and the photograph substrate individually prior to coating the adhesive and assembling the same together, or they may be made at the same time in one operation after the adhesive has been coated and the substrates have been assembled together.

As an optional advantage, particularly when the photograph substrate 12 is square or rectangular, the edge 20 of the main image receiving portion 16 may be formed so that its corners are radiused or rounded instead of 90 degrees. This is beneficial because it allows the resulting main portion 16 to have rounded corners without concern of extra ink or other print media in the printer. Specifically, many photo printing programs are designed to print on substrates with 90 degrees corners, and feeding a substrate with rounded corners into the printer means some ink or other media will be deposited at the corners beyond the extent of the corners. That is, because the rounded corners do not extend as far as 90 degree corners, the printer will attempt to deposit ink in the areas where it would expect the 90 degree corners to extend. With the removable border portion 18, this issue is eliminated, as the border portion 18 can have full 90 degree corners, while the main image receiving portion 16 has rounded corners.

The foregoing illustrated embodiment has been provided solely for illustrating the structural and functional principles of the present invention, and is not intended to be limiting. To the contrary, the present invention is intended to encompass all modifications, substitutions, alterations and equivalents within the spirit and scope of the appended claims.

What is claimed:

1. A system for making a photograph comprising:
a photograph substrate having a photographic image printable surface onto which a printer can print a photographic image;
the photograph substrate having a main image receiving portion for receiving the photographic image and a relatively thin border portion releasably attached along an entire peripheral edge of the main portion, the border portion being manually separable from the main portion.

2. A system according to claim 1, wherein the border portion and the main image receiving portion are separated by a structurally weakened portion of the photograph substrate extending around the main image receiving portion.

3. A system according to claim 2, wherein the structurally weakened portion of the photograph substrate includes a frangible connection extending around the main image receiving portion.

4. A system according to claim 3, wherein the frangible connection includes a series of spaced apart perforations extending around the main image receiving portion.

5. A system according to claim 3, wherein the frangible connection is a continuous score line extending around the main image receiving portion.

6. A system according to claim 1, wherein the photograph substrate is generally rectangular in shape.

7. A system according to claim 6, wherein the main image receiving portion is also generally rectangular in shape.

8. A system according to claim 6, wherein the photograph substrate is about 4 inches by 6 inches.

9. A system according to claim 7, wherein the photograph substrate is about 4 inches by 6 inches, wherein the border portion is in the range of 1/16 inch to 3/16 inch.

10. A system according to claim 1, wherein the border portion is the range of 1/16 inch to 3/16 inch.

11. A method for making a photograph:
(a) providing a system comprising a photograph substrate having a photographic image printable surface onto which a printer can print a photographic image, the photograph substrate having a main image receiving portion and a relatively thin border portion releasably attached along an entire peripheral edge of the main portion, the border portion being manually separable from the main portion;
(b) printing an image on the photographic image printable surface at least on the main image receiving portion; and
(c) manually separating the relatively thin border portion from the entire peripheral edge of the main image receiving portion.

12. A system according to claim 11, wherein the border portion and the main image receiving portion are separated by a structurally weakened portion of the photograph substrate extending around the main image receiving portion, and wherein manually separating the border portion includes breaking the structurally weakened portion around the main image receiving portion.

13. A system according to claim 12, wherein the structurally weakened portion of the photograph substrate includes a frangible connection extending around the main image receiving portion, and wherein manually separating the border portion includes breaking the frangible connection around the main image receiving portion.

14. A system according to claim 13, wherein the frangible connection includes a series of spaced apart perforations extending around the main image receiving portion, and wherein manually separating the border portion includes breaking the connection around the main image receiving portion along the perforations.

15. A system according to claim 13, wherein the frangible connection is a continuous score line extending around the main image receiving portion, wherein manually separating the border portion includes breaking the connection around the main image receiving portion along the score line.

16. A system according to claim 11, wherein the photograph substrate is generally rectangular in shape.

17. A system according to claim 16, wherein the main image receiving portion is also generally rectangular in shape.

18. A system according to claim 16, wherein the photograph substrate is about 4 inches by 6 inches.

19. A system according to claim 17, wherein the photograph substrate is about 4 inches by 6 inches, wherein the border portion is in the range of 1/16 inch to 3/16 inch.

20. A system according to claim 11, wherein the border portion is the range of 1/16 inch to 3/16 inch.
